(19) United States
(12) Patent Application Publication
(10) Pub. No.: US 2022/0234805 A1
(43) Pub. Date: Jul. 28, 2022

(54) PACKAGING DEVICE WITH CLAMPING MECHANISM FOR FIXING AN ARTICLE

(71) Applicant: Carl Zeiss Meditec AG, Jena (DE)

(72) Inventors: Jonathan Essig, Aalen (DE); Christian Beder, Aalen (DE)

(21) Appl. No.: 17/581,913

(22) Filed: Jan. 22, 2022

(30) Foreign Application Priority Data
Jan. 22, 2021 (DE) 10 2021 101 434.4

(51) Int. Cl. B65D 81/05; B65D 85/38

(52) U.S. Cl. CPC B65D 81/05; G02B 25/002; B65D 85/38

(57) ABSTRACT

A packaging device, which has a cavity with an opening, an outer side and an inner side, is provided. A clamping mechanism, which is configured such that an article can be releasably fastened in the cavity with the clamping mechanism, is formed on the inner side, wherein the clamping mechanism can be set from a first operating position (securing position) into a second operating position (released position) when a force acts on at least one fixed pressure point on the outer side.

### CROSS REFERENCE TO RELATED APPLICATIONS

This application claims priority to German patent application DE 10 2021 101 434.4, filed Jan. 22, 2021, the entire content of which is incorporated herein by reference.

### TECHNICAL FIELD

The present disclosure relates to a packaging device, in particular for receiving at least one sterile optical component, such as for example a magnifying glass. The disclosure additionally relates to the use of such a packaging device. The disclosure additionally relates to a packaged optical component and to a method for unpacking the packaged optical component.

### BACKGROUND

For packaging sterile articles or sterile items, packagings that are formed for example as a see-through pack, also known as a blister, are typically used. The sterile item may then be arranged as lying freely in the blister or securely clamped in it. In the case of a commercially available blister, its use during preparation for a medical operation proceeds by a first, typically unsterile, person opening the Tyvek film of the blister and a second, typically sterile, person taking out the sterile item that is in the blister from the blister. This is the case both when the sterile item is lying freely in the blister and when the sterile item is securely clamped in the blister. If the sterile item is lying freely in the blister, the procedure may also take the form that a first, unsterile, person opens the blister and subsequently empties it over a sterile operating table. The sterile item then falls onto the operating table. This creates the problem that, in particular dependent on the blister geometry, the blister must be positioned relatively high above the operating table, and consequently the sterile item falls onto the operating table from a relatively large height. This potentially damages the sterile item.

The film is usually removed in a normal position, with the sterile item lying under the film to be removed. Then the blister is usually turned varyingly briskly through 180° to empty it. The turning of the blister produces additional acceleration and rotation of the sterile item during emptying. Moreover, conventional mounting or clamping of the sterile item sometimes additionally gives the sterile item an acceleration of its own in the direction of the operating table. In other words, the sterile item shoots out of the blister in an uncontrolled manner. For this reason, some sterile items are securely clamped in a second, inner sterile package. This assembly comprising the inner package and the sterile item for its part lies freely in the blister and is tipped onto the operating table as an assembly. Although this provides better protection for the sterile item, here again a second, sterile, person must subsequently take the sterile item out of the inner packaging.

### SUMMARY

Against the described background, it is an object of the present disclosure to provide an improved packaging device which makes it possible in particular for the packaged article to be removed in a controlled manner by a person who for their part does not touch the article during the unpacking process. A further object is to provide a packaged optical component.

The objects are achieved by a packaging device and a packaged optical component as described herein.

The packaging device according to an aspect of the disclosure has a cavity with an opening, an outer side and an inner side. A clamping mechanism is formed on the inner side. The clamping mechanism is configured such that an article can be releasably fastened in the cavity with the clamping mechanism. In this case, the clamping mechanism can be set from a first operating position, typically a securing position, into a second operating position, typically a released position, by the effect of a force acting on at least one fixed pressure point on the outer side. In particular, a number of pressure points may be provided in the form of a fixed pressure region. In this case, the second operating position can be set by the effect of a force acting on this pressure region.

The packaging device according to an aspect of the disclosure has the advantage that clamping in of an article to be packaged, for example a sterile article, is made possible by the described design. Consequently, the article to be packaged is fixed during transport, and especially sensitive locations, such as for example optically effective surfaces, are protected from damage. With a clamped article in the packaging device, both the removal procedure involving two persons, for example an unsterile person and a sterile person, and the procedure involving only one person, for example a non-sterile person, are possible.

The geometry of the packaging device is typically configured such that the clamping of the article, for example the sterile item, can be released by slight pressure on the outer side or the bottom, that is to say by slight pressure on the fixed pressure point. This has the advantage that the packaging device, for example the blister, can be oriented with the open side downward by the, in particular unsterile, person while the sterile item is still clamped in the clamping mechanism. This allows the sterile item to be positioned as near as possible over the operating table before being released from the clamping. As a consequence, after being released from the clamping, the sterile item only reaches a minimal speed before reaching the operating table. In this way, the sterile item is protected from possible damage.

It is ensured by the configuration according to an aspect of the disclosure that the pressure that is required for releasing the article, in particular the sterile item, from the clamping mechanism does not cause the article to shoot out. Such shooting out would be caused by resilient pretensioning and sudden relaxation of the material of the packaging device or of the blister material.

According to an aspect of the disclosure, the inner side of the cavity includes a bottom surface, which is arranged opposite from the opening. The clamping mechanism includes a first elevation and a second elevation, which protrude from the bottom surface into the cavity. Corresponding depressions may be present on the outer side. The first elevation has at least one projection extending in the direction of the second elevation and the second elevation has at least one projection extending in the direction of the first elevation. The projections are configured to releasably fix, in particular firmly clamp, the article to be packaged between the elevations. The geometry of the elevations and the projections is typically adapted to the geometry of the article to be clamped.

The elevations are advantageously configured such that, under the effect of a force acting on the fixed pressure point, they move apart or away from one another or in other words they spread open or the distance between the elevations increases. This configuration prevents the packaged article from shooting out during the transfer from the first operating position into the second operating position. On account of the height of the elevations, measured from the bottom surface, the effect of a force acting on the pressure point produces a relative movement which releases the clamping of the fastened article in a way similar to a vice. The material of the clamping mechanism in the region of the fastened article is not elastically deformed during the release of the clamping. The deformation and internal stresses occur exclusively at the transition between the elevations and the bottom surface. In this way, undesired shooting out of the fastened article is prevented.

According to a further aspect of the disclosure, a planar surface is defined by the opening. The effect of a force acting in a normal direction perpendicular to the planar surface, that is to say in the direction of a surface normal of the defined planar surface, brings about setting of the second operating position. In other words, the fixed pressure point can be actuated by the effect of a force acting in the normal direction. Under the effect of a force acting on the at least one pressure point, the elevations typically move apart in a direction perpendicular to the normal direction, that is to say in other words radially apart in relation to the normal direction. The described geometrical design makes a precisely controllable transfer back and forth between the first operating position and the second operating position possible in a mechanically very easy way without plastic deformation and with only minimal elastic deformation.

The packaging device is advantageously designed in one piece. This represents a variant that can be easily produced, saves material and is inexpensive. However, other design variants are also conceivable, in particular multi-piece variants in which for example existing packaging devices are retrofitted with a corresponding clamping mechanism.

The packaging device according to an aspect of the disclosure may include just one clamping mechanism or else multiple clamping mechanisms. Multiple clamping mechanisms may be of advantage in the case of articles to be packaged with complex geometries and/or an unfavorable position of the center of gravity.

The elevations and/or the projections are typically arranged symmetrically in relation to one another, for example mirror-symmetrically in relation to one another, with respect to a mirror plane perpendicular to a plane defined by the opening. This makes simultaneous and uniform control of the movement of both elevations and projections with respect to one another possible, whereby in particular controlled removal of the clamped article is possible.

The at least one pressure point is typically arranged with respect to the projections such that a perpendicular or projection of the pressure point onto a shortest connecting line between the two projections, that is to say between the projection of the first elevation and the projection of the second elevation, intersects this connecting line at a point between the two projections. This makes deliberate and uniform actuation of the elevations, and consequently of the projections, possible in a mechanically easy way.

Furthermore, the material and the geometry of the elevations may be chosen such that no force acts on the elevations in the first operating position. Therefore, in other words, in the first operating position there is no stress, in particular no elastic pretensioning, that may promote uncontrolled shooting out of the fastened article from the packaging device.

The article may be at least one optical component, in particular an optical lens, for example a magnifying glass. This opens up advantageous areas of use for medical applications. The optical component may be enclosed by a further blister and the article may in this variant be formed by the further blister and the component packaged therein.

The two elevations, that is to say the first elevation and the second elevation, may be connected to one another by way of a V-shaped connecting portion or connecting region. In this case, the V-shaped connecting portion forms at the tip of the V an edge that is directly connected to the pressure point. In particular in the case of a one-piece design, the V-shaped connecting portion is a region of the packaging device which in a section perpendicular to a planar surface defined by the opening takes the form of a “V,” or in other words has a region which is formed by the two elevations while including an acute angle. The described configuration makes an optimum force transmission possible from the pressure point to the two elevations, in particular to the two projections. This makes a very measured and sensitive transfer of the packaging device, specifically the clamping mechanism, from the first operating position into the second operating position possible.

The use of a packaging device according to an aspect of the disclosure described above concerns the use of the packaging device for the sterile packaging of at least one optical component, for example a lens, in particular a magnifying glass. The component to be packaged in a sterile manner may be configured for medical operations.

The packaged optical component according to an aspect of the disclosure is distinguished by the fact that the component is arranged in the cavity of a packaging device according to an aspect of the disclosure described above. In this case, the component is releasably fastened in the cavity with the clamping mechanism. As already mentioned, the component may be a lens, for example a magnifying glass. The optical component is typically configured for use in the course of an operation. It may in particular be a disposable magnifying glass.

The packaged optical component may optionally be enclosed in the cavity, the opening being covered for example with a film or in some other way, which typically seals the cavity firmly but releasably. According to a method for unpacking the packaged optical component, first the opening of the packaging device is opened. This may for example involve pulling off a film sealing the opening, and thereby exposing the opening. In a further step, the packaging device may be positioned with the opening downward, typically over a surface. In a third step, the second operating position is set by the effect of a force acting on the pressure point, for example by the effect of a pressure applied with a finger. As a result, for example, the two elevations, and consequently the at least two projections, can spread open and release the component from the clamping mechanism, and as a consequence also from the packaging device. The method has the advantages already mentioned above, in particular in connection with operations and sterile-packaged articles.

The disclosure is explained in greater detail below on the basis of exemplary embodiments and with reference to the accompanying figures. Although the disclosure is more specifically illustrated and described in detail with the exemplary embodiments, nevertheless the disclosure is not restricted by the examples disclosed and other variations can be derived therefrom by a person of ordinary skill in the art, without departing from the scope of protection of the disclosure.

The figures are not necessarily accurate in every detail and to scale and can be presented in enlarged or reduced form for the purpose of better clarity. For this reason, functional details disclosed here should not be understood to be limiting, but merely to be an illustrative basis that gives guidance to a person skilled in this technical field for using the present disclosure in various ways.

The expression “and/or” used here, when it is used in a series of two or more elements, means that any of the elements listed can be used alone, or any combination of two or more of the elements listed can be used. For example, if a structure is described as containing the components A, B and/or C, the structure can contain A alone; B alone; C alone; A and B in combination; A and C in combination; B and C in combination; or A, B, and C in combination.

### BRIEF DESCRIPTION OF THE DRAWINGS

The disclosure will now be described with reference to the drawings wherein:

FIG. 1 schematically shows an operating table with a sterile article released from its packaging over it.

FIG. 2 schematically shows a packaging device according to an exemplary embodiment of the disclosure in a plan view.

FIG. 3 schematically shows an enlarged detail of the packaging device shown in FIG. 2 in a plan view.

FIG. 4 schematically shows a partial region of the packaging device shown in FIG. 2 in a perspective and partially sectioned view.

FIG. 5 schematically shows the packaging device shown in FIG. 2 in a perspective view.

FIG. 6 schematically shows a perpendicular of the pressure point onto a shortest connecting line between the two projections.

### DESCRIPTION OF EXEMPLARY EMBODIMENTS

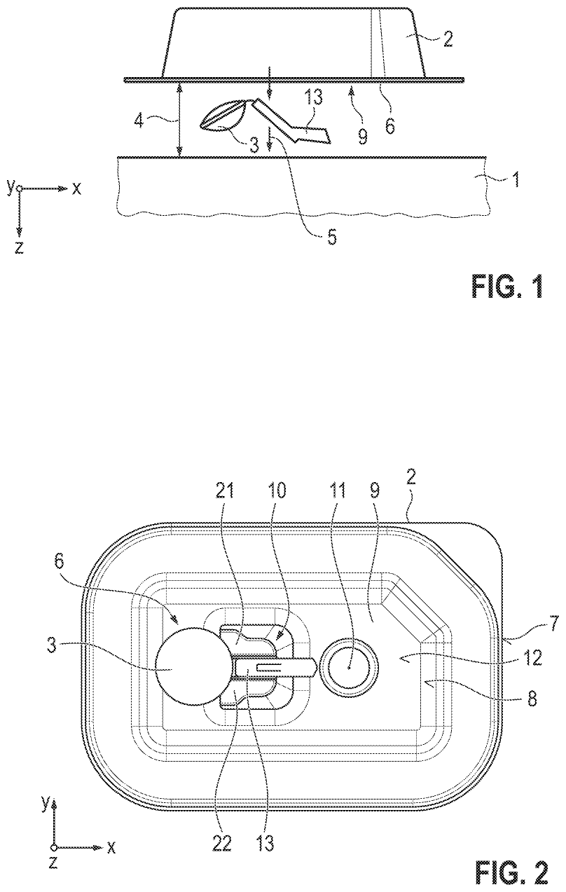

FIG. 1 schematically shows the starting situation, from which the present disclosure follows. In FIG. 1, an operating table 1 is shown. In the course of an operation on this table 1, an article 3, for example a magnifying glass, packaged in a sterile manner in a packaging device in the form of a blister 2, or blister pack, is to be used. The magnifying glass 3 includes a mounting 13. The blister 2 has a cavity 9, in which the magnifying glass 3 has been arranged, and an opening 6, through which the magnifying glass 3 can be taken out of the blister 2. The opening 6 is typically covered with a film during the packaged state. After removing the film, the packaged article, in the present case the magnifying glass 3, can be removed from the blister 2. This typically takes place, as described at the beginning, by tipping out the magnifying glass 3 from a certain distance 4 from the operating table 1. The direction of movement or falling direction of the magnifying glass 3 is in this case indicated by the reference sign 5. As already described above, by turning over the blister 2 in the open state, the magnifying glass 3 falls out of the blister 2 in a comparatively uncontrolled manner. With the present disclosure, it is intended for this situation to be avoided.

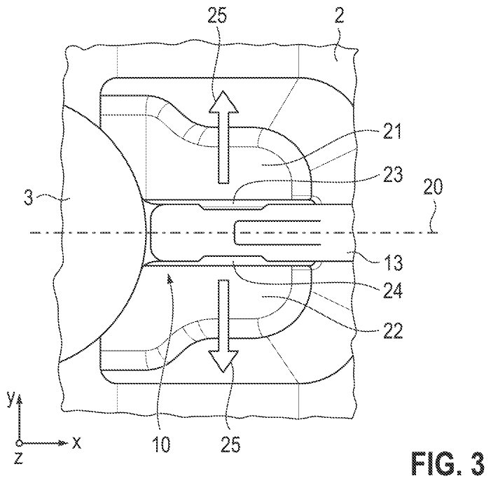

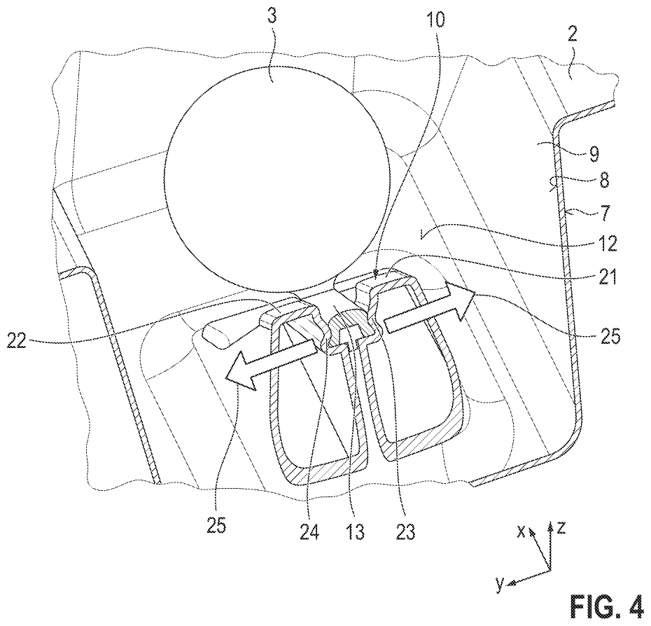

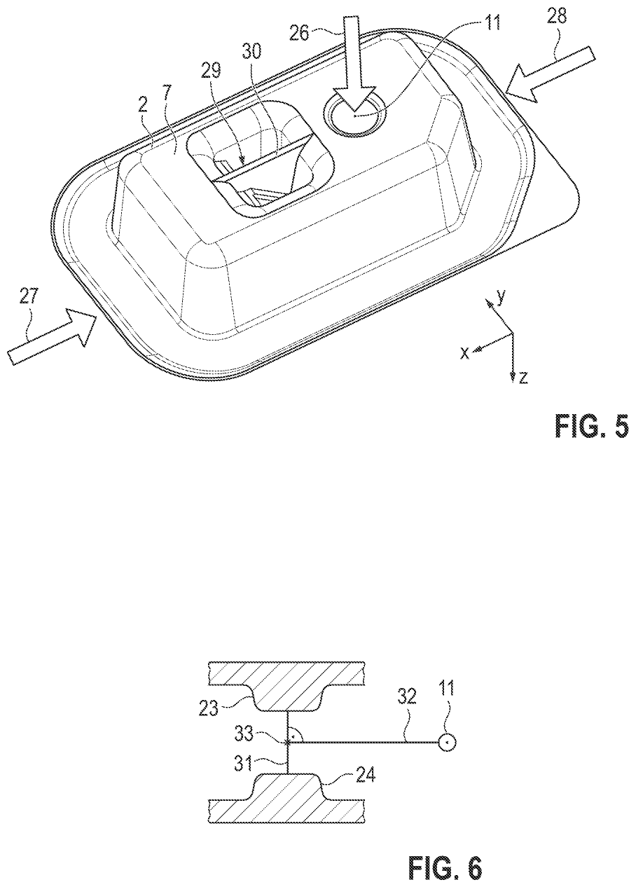

A packaging device according to an exemplary embodiment of the disclosure, which may be configured for example as a blister, is explained in more detail below on the basis of FIGS. 2 to 5. FIG. 2 schematically shows a packaging device according to an exemplary embodiment of the disclosure in a plan view. FIG. 3 schematically shows an enlarged detail of the packaging device shown in FIG. 2 in a plan view. FIG. 4 schematically shows a partial region of the packaging device shown in FIG. 2 in a perspective and partially sectioned view. FIG. 5 schematically shows the packaging device shown in FIG. 2 in a perspective view.

FIGS. 2 and 3 show the packaging device 2 according to an exemplary embodiment of the disclosure in a plan view looking into the opened packaging device. The packaging device 2 is configured to receive at least one, for example sterile, article 3 to be packaged, which may be for example an optical component, in particular a magnifying glass. For this purpose, the packaging device 2 has a cavity 9. The packaging device 2 also has an outer side 7 and an inner side 8. A clamping mechanism 10 is formed on the inner side 8. In addition, a pressure point 11 for actuating the clamping mechanism 10 is present. The pressure point 11 is typically configured as a pressure region formed by a plurality of pressure points.

In the exemplary embodiment shown, arranged on the optical component to be packaged, for example the magnifying glass 3, is a mounting 13, with which the optical component 3 can be fastened within the packaging device 2 by the clamping mechanism 10. The clamping mechanism 10 and the mounting 13 fastened by it, in particular firmly clamped, are shown enlarged in FIGS. 3 and 4. The clamping mechanism 10 has in the exemplary embodiment shown two elevations 21 and 22, extending from a bottom surface 12 of the inner side 8 in the direction of the opening 6. In the exemplary embodiment shown, a first elevation 21 and a second elevation 22 are present. The elevations 21 and 22 are in this case designed symmetrically with respect to a longitudinal axis 20. The first elevation 21 has a projection 23, directed in the direction of the second elevation 22. The second elevation 22 has a projection 24, directed in the direction of the first elevation 21. The projections 23 and 24 are designed for the purpose of releasably fixing, in particular firmly clamping, the mounting 13 between the elevations 21 and 22.

In FIGS. 2 to 5, the clamping mechanism 10 is shown in a first operating position, specifically a securing position, in which the mounting is firmly clamped between the elevations 21 and 22. A second operating state or a second operating position, specifically a released position, can be set by a force being exerted from the outer side 7 onto the pressure point or pressure region 11. This can be realized for example by a user using a finger to exert pressure on the pressure point 11 from the outer side.

The effect of the force has the consequence that the elevations 21 and 22 spread open, and therefore the distance between the elevations 21 and 22, and consequently also between the projections 23 and 24, increases. The direction of movement of the elevations 21 and 22 thus achieved, resulting from the effect of the force, is indicated in FIGS. 3 and 4 by arrows 25. In FIG. 5, the effect of the external force acting on the pressure point 11 from the outer side 7 on the bottom surface 12 is indicated by an arrow 26. The arrows 27 and 28 indicate directions from which the packaging device 2 can for example be securely held by a first hand (see arrow 27) and/or by a second hand (see arrow 28).

The elevations 21 and 22 are typically directly connected to one another by way of a V-shaped region or portion 29. The packaging device 2 is typically designed in one piece. The V-shaped region 29 has in this case an edge 30, which is directly connected to the pressure point 11, for example in its extension intersects the pressure point 11. In this way, an optimum force transmission is achieved, minimizing deformation of the packaging device 2 and having the result that the effect of the force primarily brings about a relative movement of the elevations 21 and 22, and consequently also of the projections 23 and 24, in relation to one another. As a result, a controlled release of the article 3 from the packaging device 2 can be accomplished, even in a position with the opening 6 directed downward. The magnifying glass 3 can consequently be released in a measured manner, and consequently the packaging device can be placed just a very small distance from the operating table 1 when removing the magnifying glass from the packaging. As a result, on the one hand damage to the magnifying glass 3 is avoided and on the other hand it is ensured that the magnifying glass 3 does not fall off the operating table 1 due to uncontrolled accelerations.

In an exemplary geometrical configuration, a planar surface is defined by the opening 6. This is indicated in the figures by an x-y plane. The effect of the force 26 typically takes place in a normal direction perpendicular to the x-y plane, that is to say in the z direction. In order to realize the described relative movement of the elevations 21 and 22 optimally in relation to one another, the pressure point 11 is typically arranged with respect to the elevations 21 and 22 such that a perpendicular 32 of the pressure point 11 onto a shortest connecting line 31 between the two projections 23 and 24 intersects this connecting line at a point 33 that lies between the projections 23 and 24. FIG. 6 illustrates this schematically.

It is understood that the foregoing description is that of the exemplary embodiments of the disclosure and that various changes and modifications may be made thereto without departing from the spirit and scope of the disclosure as defined in the appended claims.

### LIST OF REFERENCE NUMERALS

1 Operating table
2 Packaging device/blister
3 Article/optical component/magnifying glass
4 Distance
5 Falling direction
6 Opening
7 Outer side
8 Inner side
9 Cavity
10 Clamping mechanism
11 Pressure point/pressure region
12 Bottom surface
13 Mounting
20 Longitudinal axis
21 First elevation
22 Second elevation
23 Projection
24 Projection
25 Direction of movement
26 Effect of force acting on the pressure point
27 Holding direction
28 Holding direction
29 V-shaped region/portion
30 Edge
31 Connecting line
32 Perpendicular
33 Point of intersection
x Spatial direction
y Spatial direction
z Spatial direction

What is claimed is:

1. A packaging device, comprising:
a cavity with an opening, an outer side having at least one fixed pressure point, and an inner side; and
a clamping mechanism formed on the inner side and configured such that an article can be releasably fastened in the cavity with the clamping mechanism, wherein the clamping mechanism can be set from a first operating position (securing position) into a second operating position (released position) by a force acting on the at least one fixed pressure point on the outer side.

2. The packaging device as claimed in claim 1, wherein:
the inner side comprises a bottom surface which is arranged opposite from the opening,
the clamping mechanism comprises a first elevation and a second elevation which protrude from the bottom surface into the cavity,
the first elevation has at least one projection extending in the direction of the second elevation and the second elevation has at least one projection extending in a direction of the first elevation, and
the projections are configured to releasably fix the article between the first and second elevations.

3. The packaging device as claimed in claim 2, wherein the first and second elevations are configured such that, when the force is applied to the at least one fixed pressure point, a distance between the first and second elevations increases.

4. The packaging device as claimed in claim 2, wherein:
a planar surface is defined by the opening, and
when a force acts in a normal direction perpendicular to the planar surface, the second operating position is set.

5. The packaging device as claimed in claim 4, wherein, when the force acts on the at least one fixed pressure point, the first and second elevations move apart in a direction perpendicular to a normal direction.

6. The packaging device as claimed in claim 1, wherein the packaging device is provided in one piece.

7. The packaging device as claimed in claim 1, wherein at least one of the first and second elevations and the projections are arranged symmetrically in relation to one another.

8. The packaging device as claimed in claim 1, wherein the at least one fixed pressure point is arranged with respect to the projections such that a perpendicular of the at least one fixed pressure point onto a shortest connecting line between the two projections intersects the shortest connecting line at a point between the two projections.

9. The packaging device as claimed in claim 2, wherein the material and the geometry of the first and second elevations are chosen such that no force acts on the elevations in the first operating position.

10. The packaging device as claimed in claim 1, wherein the article is an optical component.

11. The packaging device as claimed in claim 1, wherein:
the two elevations are connected to one another by way of a V-shaped connecting portion, and
the V-shaped connecting portion forms at the tip of the V an edge that is directly connected to the at least one fixed pressure point.

12. A packaged optical component, wherein the component is arranged in the cavity of a packaging device as claimed in claim 1, and wherein the component is releasably fastened in the cavity with the clamping mechanism.
